(19) United States
(12) Patent Application Publication
(10) Pub. No.: US 2022/0388217 A1
(43) Pub. Date: Dec. 8, 2022

(54) MANUFACTURING METHOD FOR THERMOPLASTIC RESIN COMPOSITION, MANUFACTURING METHOD FOR SHAPED BODY, AND FILM

(71) Applicant: KANEKA CORPORATION, Osaka-shi (JP)

(72) Inventor: Yoshiaki MATSUOKA, Osaka (JP)

(73) Assignee: KANEKA CORPORATION, Osaka-shi (JP)

(21) Appl. No.: 17/820,097

(22) Filed: Aug. 16, 2022

Related U.S. Application Data
(63) Continuation of application No. PCT/JP2021/010511, filed on Mar. 16, 2021.

(30) Foreign Application Priority Data
Mar. 27, 2020 (JP) 2020-058808

(51) Int. Cl. B29C 48/00; C08G 63/183; C08G 63/08; C08L 3/02; B29C 48/08; C08J 5/18

(52) U.S. Cl. CPC B29C 48/022; C08G 63/183; C08G 63/08; C08L 3/02; B29C 48/08; C08J 5/18; C08G 2230/00; C08L 2205/025; C08L 2205/035; C08L 2205/18; C08L 2203/16; C08L 2203/30; B29K 2003/00; B29K 2067/006

(57) ABSTRACT

A method for producing a thermoplastic resin composition, including: melt-kneading a mixture containing a polyester resin (A), a starch material (B), and water; and dewatering the melt-kneaded mixture to reduce a water content to 5% by weight or less. The mixture contains 25 to 55 parts by weight of the water per 100 parts by weight of a solid content of the starch material (B). A film containing a thermoplastic resin composition containing a biodegradable polyester resin (A) and a starch material (B), wherein the starch material (B) has a number-average particle diameter of 3 μm or less.

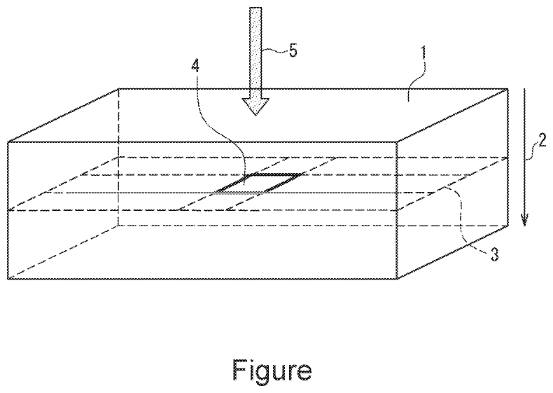

### CROSS-REFERENCE TO RELATED APPLICATIONS

The present application is a continuation of International Application No. PCT/JP2021/010511, filed on Mar. 16, 2021, and claims priority to Japanese Application No. 2020-058808, filed on Mar. 27, 2020, the entire disclosures of both of which are incorporated herein by reference in their entireties.

### TECHNICAL FIELD

The present invention relates to a production method of a thermoplastic resin composition containing a biodegradable resin, a production method of a molded article containing a biodegradable resin, and a film containing a biodegradable resin.

### BACKGROUND ART

Biodegradable resins, particularly biobased biodegradable resins, are attracting attention to address the plastic waste problem and make the shift from fossil fuels. Among them, highly biodegradable aliphatic-aromatic polyesters, typified by polybutylene adipate terephthalate (PBAT), and highly biodegradable aliphatic polyesters, typified by poly-(3-hydroxybutyrate-co-3-hydroxyhexanoate), polybutylene succinate (PBS), polycaprolactone (PCL), and polylactic acid (PLA), are drawing attention. Especially, PHBH produced using biobased raw materials through a microbial culture is of particular interest because the biodegradation rate is extremely fast and it decomposes in various conditions from the aerobic to anaerobic conditions, and from the soil to the sea. In addition, starches of natural plant resin having excellent biodegradability and a mechanical property improving effect also have been studied to make them finely dispersed in a biodegradable polyester resin to be combined therewith.

Patent Document 1 discloses that 10 to 60 parts by weight of a plasticizer for starch is mixed with 100 parts by weight of a starch material to soften the starch material, and the mixture is finely dispersed in a polyester resin. Patent Document 2 discloses that a mixture containing a polyester resin and at least one of a starch or a starch derivative is homogenized by application of at least one of thermal energy or mechanical energy.

### PRIOR ART DOCUMENTS

### Patent Documents

Patent Document 1: JP 2009-155530 A
Patent Document 2: JP 2011-500934 A

### DISCLOSURE OF INVENTION

### Problem to be Solved by the Invention

In Patent Document 1, the surface of a resultant molded article is sticky due to a bleeding additive such as a plasticizer for starch, resulting in poor surface smoothness. In Patent Document 2, a large amount of heat applied to the resin during homogenization makes the odor derived from starch strong.

In order to solve the above conventional problems, the present invention provides a method for producing a thermoplastic resin composition containing a biodegradable polyester resin and a starch material and from which a molded article having improved surface smoothness with less odor is obtained, and a method for producing the molded article.

To solve the above conventional problems, the present invention further provides a film having improved surface smoothness in which a starch material is finely dispersed in a biodegradable polyester resin.

### Means for Solving Problem

One or more embodiments of the present invention relates to a method for producing a thermoplastic resin composition containing a biodegradable polyester resin (A) and a starch material (B), the method including:

a first step of melt-kneading a mixture containing the polyester resin (A), the starch material (B), and water, the mixture containing the water in an amount of 25 parts by weight or more and 55 parts by weight or less per 100 parts by weight of the solid content of the starch material (B); and

a second step of dewatering the melt-kneaded mixture to reduce a water content of the melt-kneaded mixture to 5% by weight (hereinafter, simply referred to as “wt %”) or less.

Further, one or more embodiments of the present invention relates to a method for producing a molded article including a step of molding the thermoplastic resin composition produced by the above production method of the thermoplastic resin composition.

Furthermore, one or more embodiments of the present invention relates to a film containing a thermoplastic resin composition containing a biodegradable polyester resin (A) and a starch material (B),

wherein the starch material (B) has a number-average particle diameter of 3 μm or less.

### Effect of the Invention

The production method of the thermoplastic resin composition according to the present invention enables production of a thermoplastic resin composition containing a biodegradable polyester resin and a starch material and from which a molded article having improved surface smoothness with less odor is obtained.

The present invention further provides a film having improved surface smoothness in which a starch material is finely dispersed in a biodegradable polyester resin.

### BRIEF DESCRIPTION OF DRAWINGS

The FIGURE is a schematic explanatory view illustrating a method for measuring the particle diameter of the starch material (B) in the film.

### DESCRIPTION OF THE INVENTION

The present inventors conducted intensive studies to solve the above problems and found that in the production of a thermoplastic resin composition containing a biodegradable polyester resin and a starch, melt-kneading the biodegradable polyester resin (A) and the starch material (B) with a certain amount of water and in a subsequent step dewatering the melt-kneaded mixture enables the production of a thermoplastic resin composition from which a molded article having improved smoothness with less odor is obtained.

(Thermoplastic resin composition and its production method) The production method of the thermoplastic resin composition includes a step of melt-kneading a mixture containing the polyester resin (A), the starch material (B), and water, wherein the mixture contains water in an amount of 25 parts by weight or more and 55 parts by weight or less per 100 parts by weight of the solid content of the starch material (B) (first step). In the first step, the addition of water in an amount of 25 parts by weight or more and 55 parts by weight or less per 100 parts by weight of the solid content of the starch material (B) in the mixture containing the polyester resin (A), the starch material (B), and water, causes the starch material (B) to be dispersed in the polyester resin (A) without the necessity of, or with a minimal use of, a plasticizer for starch and without increasing the shearing force during melt kneading more than necessary (e.g., not increasing the screw rotation speed higher than 300 rpm), and consequently yielding a molded article having improved surface smoothness with less odor. The mixture preferably contains water in an amount of 28 parts by weight or more and 50 parts by weight or less, and more preferably 30 parts by weight or more and 40 parts by weight or less per 100 parts by weight of the solid content of the starch material (B). Normally, a commercially available starch material (B) contains water. In this case, in one or more embodiments of the present invention, “water” includes water derived from the starch material (B) and added water. Therefore, water in the mixture may contain the water derived from the starch material (B). In one or more embodiments of the present invention, when the starch material (B) not containing water is used, water means added water. The water content (moisture content) of the starch material (B) is measured by placing a starch material sample on a moisture meter set at 160° C. and measuring a volatile content ratio at which a change in volatile content becomes less than 0.02%. The amount of the solid content of the starch material (B) can be calculated based on the moisture content of the starch material (B).

The melt kneading in the first step may be performed using a mixture containing the polyester resin (A), the starch material (B), water, and as needed other additives (described later), or a mixture containing a premix prepared in advance by mixing the starch material (B), water (added water other than the water derived from the starch material (B)), an inorganic filler, and as needed other additives; the polyester resin (A); and as needed other additives.

Any polyester resin that has biodegradability may be used as the polyester resin (A). From the viewpoint of inhibiting the hydrolysis, the polyester resin (A) preferably contains at least one selected from the group consisting of an aliphatic-aromatic polyester resin (A1) containing at least one dicarboxylic acid unit selected from the group consisting of an aliphatic dicarboxylic acid unit and an aromatic dicarboxylic acid unit, and at least one diol unit selected from the group consisting of an aliphatic diol unit and an aromatic diol unit; and an aliphatic polyester resin (A2) (other than a polyhydroxybutyrate resin) containing an aliphatic dicarboxylic acid unit and an aliphatic diol unit.

The aliphatic dicarboxylic acid unit includes aliphatic dicarboxylic acid and ester-forming derivatives thereof. Examples of the aliphatic dicarboxylic acid unit include, but are not particularly limited to, those having 2 to 30 carbon atoms, preferably those having 2 to 18 carbon atoms, and more preferably those having 4 to 10 carbon atoms. The aliphatic dicarboxylic acid unit may be linear or branched.

Specific examples of the aliphatic dicarboxylic acid unit include oxalic acid, malonic acid, succinic acid, glutaric acid, 2-methylglutaric acid, 3-methylglutaric acid, α-ketoglutaric acid, adipic acid, pimelic acid, azelaic acid, sebacic acid, undecanoic acid, dodecanoic acid, brassylic acid, fumaric acid, 2,2-dimethylglutaric acid, suberic acid (cork acid), diglycolic acid, oxaloacetic acid, glutamic acid, aspartic acid, itaconic acid, and maleic acid.

The aliphatic dicarboxylic acid and ester-forming derivatives thereof may be used alone or in combination of two or more. The aliphatic dicarboxylic acid unit is preferably at least one selected from the group consisting of succinic acid, adipic acid, azelaic acid, sebacic acid, brassylic acid, and ester-forming derivatives thereof. The aliphatic dicarboxylic acid unit is more preferably at least one selected from the group consisting of succinic acid, adipic acid, sebacic acid, and ester-forming derivatives thereof. Succinic acid, azelaic acid, sebacic acid, and brassylic acid are advantageous in that they are obtained from renewable raw materials.

The aromatic dicarboxylic acid unit is preferably, but not particularly limited to, at least one selected from the group consisting of terephthalic acid and ester-forming derivatives thereof. An example of the ester-forming derivatives of terephthalic acid is dimethyl terephthalate. Further, heterocyclic aromatic dicarboxylic acid also can be used as the aromatic dicarboxylic acid unit, and an example thereof is 2,5-furandicarboxylic acid.

The aliphatic diol unit may be, but not particularly limited to, a branched or linear alkane diol having 2 to 12 carbon atoms, and preferably a branched or linear alkane diol having 4 to 6 carbon atoms, for example.

Examples of the alkane diol include, but are not particularly limited to, ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol (neopentyl glycol), 2-ethyl-2-butyl-1,3-propanediol, 2-ethyl-isobutyl-1,3-propanediol, and 2,2,4-trimethyl-1,6-hexanediol.

The aliphatic diol unit may be, but not particularly limited to, cycloalkane diol having 5 to 10 carbon atoms, for example. Examples of the cycloalkane diol include cyclopentanediol, 1,4-cydohexanediol, 1,2-cydohexanedimethanol, 1,3-cydohexanedimethanol, 1,4-cydohexanedimethanol, and 2,2,4,4-tetramethyl-1,3-cydobutanediol.

Examples of the aromatic diol include 4,4′-dihydroxybiphenyl, hydroquinone, resorcin, 2,6-dihydroxynaphthalene, 2,2-bis(4-hydroxyphenyl)propane, and bis-(4-hydroxyphenyl)sulfone.

As the diol unit, for example, 1,4-butanediol and 1,3-propanediol are preferable. Particularly, 1,4-butanediol in combination with adipic acid is preferable, and 1,3-propanediol in combination with sebacic acid is preferable. 1,3-Propanediol is advantageous in that it is obtained as a renewable raw material.

Examples of the aliphatic-aromatic polyester resin (A1) include polybutylene adipate terephthalate (PBAT) resin, polybutylene sebacate terephthalate resin, and polybutylene succinate terephthalate resin. Specific examples of the polybutylene adipate terephthalate (PBAT) resin include polybutylene adipate terephthalate (PBAT) and polybutylene azelate terephthalate (PBAzT). Particularly, polybutylene adipate terephthalate (PBAT) is preferable in terms of excellent physical properties, such as the tensile elongation to break, and excellent moldability.

Polybutylene adipate terephthalate (PBAT) is a random copolymer of 1,4-butanediol, adipic acid, and terephthalic acid. Among PBATs, PBAT such as that described in JP H10-508640 is preferable, which is obtained by a reaction of a mixture (a) mainly containing 35 mol % or more and 95 mol % or less of adipic acid or an ester-forming derivative thereof or a mixture of these and 5 mol % or more and 65 mol % or less of terephthalic acid or an ester-forming derivative thereof or a mixture of these (the total mol % of the individual monomers is 100 mol %), with a mixture (b) containing butanediol (the molar ratio of (a) and (b), (a):(b), is 0.4:1 to 1.5:1). An example of PBAT is a commercially available “ECOFLEX” (registered trademark) manufactured by BASF SE.

The weight-average molecular weight of the aliphatic-aromatic polyester resin (A1) is preferably, but not particularly limited to, 1000 or more and 100000 or less, more preferably 9000 or more and 75000 or less, and further preferably 10000 or more and 50000 or less, for example. In one or more embodiments of the present invention, the weight-average molecular weight of resin refers to a weight-average molecular weight in terms of polystyrene measured by gas permeation chromatography (GPC) using chloroform as a solvent.

The melting point of the aliphatic-aromatic polyester resin (A1) is preferably, but not particularly limited to, 60° C. or higher and 170° C. or lower, and more preferably 80° C. or higher and 150° C. or lower, for example.

Examples of the aliphatic polyester resin (A2) include polybutylene succinate (PBS) resin, polycaprolactone (PCL) resin, and polyhydroxyalkanoate resin (other than polyhydroxybutyrate resin). Specific examples of the polybutylene succinate (PBS) resin include polybutylene succinate (PBS) and polybutylene succinate adipate (PBSA).

The polyhydroxyalkanoate resin other than polyhydroxybutyrate resin refers to polyhydroxyalkanoate resin not containing 3-hydroxybutyrate as a monomer component, and examples thereof include polyglycolic acid, polylactic acid, and poly-4-hydroxybutyrate resins.

The poly-4-hydroxybutyrate resin may be poly(4-hydroxybutyrate) containing 4-hydroxybutyrate as a single repeating unit, or a copolymer of 4-hydroxybutyrate and another hydroxyalkanoate.

The starch material (B) may be at least one selected from the group consisting of starches and derivatives thereof. Specific examples of the starches include a maize starch (also referred to as a corn starch), a flour starch, a rice starch, a broad bean starch, a mung bean starch, a red bean starch, a potato starch, a sweet potato starch, and a tapioca starch. The starch derivatives include chemically modified starches, and preferable examples thereof include chemically modified starches in which free OH groups in starch is at least partially substituted. Specific examples of such chemically modified starches include ether-modified starches, ester-modified starches, hydrophobic starches, hydrophilic starches, hydroxypropyl starches, and carboxymethyl starches.

Next, in the second step, the melt-kneaded mixture is dewatered to reduce a water content of the melt-kneaded mixture to 5 wt % or less. If the water content of the melt-kneaded mixture exceeds 5 wt %, strands cannot be drawn and pellets of the thermoplastic resin composition cannot be obtained. The water content of the melt-kneaded mixture is preferably 4.0 wt % or less, more preferably 3.0 wt % or less, further preferably 2.0 wt % or less, and still further preferably 1.0 wt % or less. The water content (moisture content) of the melt-kneaded mixture is measured by placing a sample on a moisture meter set at 160° C. and measuring a volatile content ratio at which a change in volatile content becomes less than 0.02%.

The production method of the thermoplastic resin composition in one or more embodiments of the present invention preferably includes a third step of further adding at least one selected from the group consisting of the aliphatic polyester resin (A2) and a polyhydroxybutyrate resin (C) to the melt-kneaded mixture obtained in the second step and melt-kneading it. Adding at least one of the aliphatic polyester resin (A2) or the polyhydroxybutyrate resin (C) after the second step can further remove the odor derived from the starch material. Although the aliphatic polyester resin (A2) and the polyhydroxybutyrate resin (C) can be added to the mixture in the first step, they are preferably added after the second step to the melt-kneaded mixture obtained in the second step, from the viewpoint of inhibiting the hydrolysis of the aliphatic polyester resin (A2) and the polyhydroxybutyrate resin (C) and further removing the odor of the thermoplastic resin composition. Particularly, the polyhydroxybutyrate resin (C) is preferably added after the second step to the melt-kneaded mixture.

The polyhydroxybutyrate resin (C) may be poly(3-hydroxybutyrate) containing 3-hydroxybutyrate as a single repeating unit, or a copolymer of 3-hydroxybutyrate and another hydroxyalkanoate. The polyhydroxybutyrate resin (C) may be a mixture of a homopolymer and at least one copolymer, or may be a mixture of two or more copolymers.

The weight-average molecular weight of the polyhydroxybutyrate resin (C) is preferably 300000 or more and 800000 or less, more preferably 350000 or more and 750000 or less, and further preferably 400000 or more and 700000 or less from the viewpoint of moldability. For example, in inflation molding, the polyhydroxybutyrate resin (C) having a weight-average molecular weight of 300000 or more imparts a sufficient melt tension to the thermoplastic resin composition while stabilizing a balloon and keeping the mold-processing range. The polyhydroxybutyrate resin (C) having a weight-average molecular weight of 800000 or less makes it easier to accelerate the discharge rate and prevents the generation of, e.g., flow marks.

The polyhydroxybutyrate resin (C) is preferably a copolymer of 3-hydroxybutyrate and another hydroxyalkanoate from the viewpoint of the mold-processing range. Examples of the copolymer include

poly(3-hydroxybutyrate-co-3-hydroxyhexanoate),
poly(3-hydroxybutyrate-co-3-hydroxyvalerate), poly
(3-hydroxybutyrate-co-4-hydroxybutyrate),
poly(3-hydroxybutyrate-co-3-hydroxyoctanoate), and
poly(3-hydroxybutyrate-co-3-hydroxyoctadecanoate). Poly(3-hydroxybutyrate) has a melting point and a decomposition temperature of around 180° C. and decomposes as the resin melts, narrowing the mold-processing range and making the molding difficult. Copolymerization can lower the melting point. For example,
poly(3-hydroxybutyrate-co-3-hydroxyhexanoate) containing 6 mol % of 3-hydroxyhexanoate has a melting point of around 145° C. and has a broad mold-processing range of 145 to 180° C.

The copolymer of 3-hydroxybutyrate and another hydroxyalkanoate preferably contains the another hydroxyalkanoate in an amount of 2 mol % or more and 15 mol % or less, and more preferably 3 mol % or more and 12 mol % or less from the viewpoint of the mold-processing range, and further preferably 3 mol % or more and 9 mol % or less, and particularly preferably 3 mol % or more and 6 mol % or less from the viewpoint of accelerating the crystallization rate and increasing the productivity.

From the viewpoint of the moldability and the mold-processing range, the polyhydroxybutyrate resin (C) is preferably a copolymer of 3-hydroxybutyrate and another hydroxyalkanoate containing the another hydroxyalkanoate in an amount of 2 mol % or more and 15 mol % or less and having a weight-average molecular weight of 300000 or more and 800000 or less, more preferably a copolymer of the above combination containing the another hydroxyalkanoate in an amount of 3 mol % or more and 12 mol % or less and having a weight-average molecular weight of 350000 or more and 750000 or less, and further preferably a copolymer of the above combination containing the another hydroxyalkanoate in an amount of 3 mol % or more and 12 mol % or less and having a weight-average molecular weight of 400000 or more and 700000 or less.

The polyhydroxybutyrate resin (C) is preferably

poly(3-hydroxybutyrate-co-3-hydroxyhexanoate) from the viewpoint of the industrially easy production and the excellent molding processability at low temperatures. The poly(3-hydroxybutyrate-co-3-hydroxyhexanoate) preferably contains 85 mol % or more and 98 mol % or less of the 3-hydroxybutyrate unit and 2 mol % or more and 15 mol % or less of the 3-hydroxyhexanoate unit, and more preferably 88 mol % or more and 97 mol % or less of the 3-hydroxybutyrate unit and 3 mol % or more and 12 mol % or less of the 3-hydroxyhexanoate unit from the viewpoint of balancing the flexibility and the strength. The poly(3-hydroxybutyrate-co-3-hydroxyhexanoate) further preferably contains 91 mol % or more and 97 mol % or less of the 3-hydroxybutyrate unit and 3 mol % or more and 9 mol % or less of the 3-hydroxyhexanoate unit, and particularly preferably 94 mol % or more and 97 mol % or less of the 3-hydroxybutyrate unit and 3 mol % or more and 6 mol % or less of the 3-hydroxyhexanoate unit from the viewpoint of high productivity. The poly(3-hydroxybutyrate-co-3-hydroxyhexanoate) has a weight-average molecular weight of preferably 300000 or more and 800000 or less, more preferably 350000 or more and 750000 or less, and further preferably 450000 or more and 700000 or less from the viewpoint of the molding processability.

The poly(3-hydroxybutyrate-co-3-hydroxyhexanoate) may be, e.g., a commercially available “KANEKA Biodegradable Polymer PHBH (registered trademark)” manufactured by KANEKA CORPORATION. Exemplary grades of the KANEKA Biodegradable Polymer PHBH include X131N, X131A, X331N, X337N, X151A, X151N, and X157N.

The polyhydroxybutyrate resin (C) is preferably a combination of two or more kinds of polyhydroxybutyrate resins having different melting points as described in WO 2015/146194, from the viewpoint of accelerating the crystallization rate, improving the melt processability, and increasing the productivity. The polyhydroxybutyrate resin (C) also may be a PHA (polyhydroxyalkanoate) mixture obtained by simultaneously producing PHAs having different melting points in cells in accordance with the PHA production method described in WO 2015/146195. Exemplary grades of the KANEKA Biodegradable Polymer PHBH produced by this method include M101 and M301.

After the third step, the method may include a step of dewatering the melt-kneaded mixture obtained in the third step, as needed. The water content in the final resulting melt-kneaded mixture needs to be 5 wt % or less to obtain pellets of the thermoplastic resin composition having a water content of 5 wt % or less.

In the production method in one or more embodiments of the present invention, melt kneading is not particularly limited and may be a common kneading method. For example, the above components may be melt-kneaded by being fed into a melt-kneader such as an extruder, a kneader, or a Banbury mixer. The above components also may be mixed in an unmolten state by, e.g., a super mixer, a Henschel mixer, or a floater, before melt kneading. After melt kneading, the melt-kneaded mixture (the thermoplastic resin composition) is extruded in strands and cut into particles in the shape of, e.g., a cylinder, elliptic cylinder, sphere, cube, or cuboid, to obtain pellets of the thermoplastic resin composition.

The extruder for melt kneading is not particularly limited and may be a single-screw extruder or a twin-screw extruder. From the viewpoint of the versatility and dispersibility, a twin-screw extruder is preferable. The twin-screw extruder preferably includes at least one cylinder (also called barrel), two screws arranged inside the cylinder, at least one raw material feeder provided in the cylinder, and at least one vent provided in the cylinder. The raw material feeder may have a main feed part and a side feed part located downstream of the main feed part in the extrusion direction. The polyester resin (A), water, and the starch material (B), or the polyester resin (A) and a pre-blend of water and the starch material (B) may be supplied from the main feed part, and the polyhydroxybutyrate resin (C) may be supplied from the side feed part. Further, of the polyester resins (A), the aliphatic-aromatic polyester resin (A1) may be supplied from the main feed part, and the aliphatic polyester resin (A2) may be supplied from the side feed part.

The production method in one or more embodiments of the present invention may use the same melt-kneader through the first, second, and third steps when the method includes the third step. Alternatively, the production method in one or more embodiments of the present invention may use another melt-kneader for the third step that is different from the melt-kneader for the first and second steps. For example, the polyester resin (A), water, and the starch material (B), or the polyester resin (A) and a pre-blend of water and the starch material (B) may be supplied to a set melt-kneading apparatus, and the melt-kneaded mixture obtained through the first and second steps is cooled and pelletized. Then, in the third step, the pelletized melt-kneaded mixture is melt-mixed with the polyhydroxybutyrate resin (C) and the aliphatic polyester resin (A2) using a different melt-kneading apparatus.

When the total weight of the polyester resin (A) and the starch material (B) to be fed from the main feed part of the extruder for melt kneading is taken as 100 wt %, the polyester resin (A) is preferably 50 wt % or more and 99 wt % or less, and the starch material (B) is preferably 1 wt % or more and 50 wt % or less; the polyester resin (A) is more preferably 55 wt % or more and 90 wt % or less, and the starch material (B) is more preferably 10 wt % or more and 45 wt % or less; and the polyester resin (A) is further preferably 60 wt % or more and 80 wt % or less, and the starch material (B) is further preferably 20 wt % or more and 40 wt % or less, from the viewpoint of further improving the surface smoothness of the molded article made from the thermoplastic resin composition.

When M represents the total weight of the polyester resin (A) and the starch material (B) to be fed from the main feed part of the extruder for melt kneading, S represents the total weight of the aliphatic polyester resin (A2) and the polyhydroxybutyrate resin (C) to be fed from the side feed part of the extruder for melt kneading of the thermoplastic resin composition, and the total of M and S is taken as 100 wt %, M is preferably 30 wt % or more and 85 wt % or less, and S is preferably 15 wt % or more and 70 wt % or less; M is more preferably 40 wt % or more and 80 wt % or less, and S is more preferably 20 wt % or more and 60 wt % or less; and M is further preferably 60 wt % or more and 80 wt % or less, and S is further preferably 20 wt % or more and 40 wt % or less, from the viewpoint of further improving the surface smoothness of the molded article made from the thermoplastic resin composition and effectively reducing the burnt odor.

The main feed part is normally arranged at the screw base. The screw configuration of the main feed part may be a common full flight screw. A single full flight screw may also be used to achieve a high discharge rate at a low screw rotation speed. The raw materials fed from the main feed part may be preheated downstream of the main feed part in the extrusion direction (hereinafter, also referred to as a preheating zone) before entering a kneading zone. In the preheating step, the polyester resin (A) can be appropriately preheated, and the starch material (B) containing an appropriate amount of water can be preheated and gelatinized. From the viewpoint of adequately gelatinizing the starch material, the screw is preferably a full flight with a small screw lead, for example, a full flight with a screw lead 0.75 times or less the screw diameter, and more preferably a full flight with a screw lead 0.5 times or less the screw diameter. From the viewpoint of homogeneously gelatinizing the starch material, a left-handed full flight screw having a reverse transfer capacity may be disposed at one or more locations. To achieve more homogeneous gelatinization, the residence time is lengthened by partially providing a seal ring with a wide gap between the barrel and the seal ring surface, providing a torpedo, introducing a dulmadge structure with torpedoes and fins arranged alternately, or introducing a feed kneading element, an orthogonal kneading element, or a kneading element having a reverse transfer capacity. In the preheating zone, the barrel temperature is preferably, but not particularly limited to, 130° C. or lower, for example. The barrel temperature of 130° C. or lower can prevent boiled water from flowing back to the main feed part and prevent water necessary for gelatinization from decreasing, thereby making it easier to reach adequate gelatinization and increase the surface smoothness of the molded article.

In the first step of melt-mixing the polyester resin (A) and the starch material (B) containing an appropriate amount of water, the barrel temperature is preferably set within a range from “Tm−40° C.” to “Tm+40° C.” to apply a high shearing stress, where Tm represents the melting point of the polyester resin (A). The barrel temperature is more preferably “Tm−30° C.” to “Tm+30° C.”, further preferably “Tm−30° C.” to “Tm+20° C.”, and particularly preferably “Tm−20° C.” to “Tm+10° C.”. The melting point in the present invention is measured according to differential scanning calorimetry. The barrel temperature in the first step of “Tm−40° C.” or higher does not increase the molding load, making it easier to accelerate the discharge rate and increase the productivity. Further, the barrel setting temperature in the first step of “Tm+40° C.” or lower makes it easier to improve the surface smoothness of the molded article.

When the aliphatic polyester resin is used, the cylinder temperature in melt kneading is preferably set at 180° C. or lower from the viewpoint of inhibiting the thermal decomposition of the aliphatic polyester resin. The temperature at the cylinder part may be 160° C. or lower from the viewpoint of further lowering the molten resin temperature and inhibiting the thermal decomposition. In the case of using an extruder that can withstand a high molding load, the cylinder temperature can be further lowered to 140° C. or lower, or even further to 120° C. or lower.

The screw rotation speed during melt kneading is not particularly limited. For example, from the viewpoint of inhibiting the thermal decomposition of resin while making melt kneading possible, the screw rotation speed in the case of using an extruder with a screw diameter of 27 mm at a discharge rate of 7 kg/hr is preferably 50 rpm or more and 250 rpm or less, more preferably 70 rpm or more and 180 rpm or less, and further preferably 90 rpm or more and 160 rpm or less. The discharge rate is increased by increasing the screw rotation speed while keeping the “discharge rate/screw rotation speed” constant. In the case of using an extruder with a large screw diameter, an optimal screw rotation speed may be shifted to a higher side.

The discharge rate of the melt-kneaded mixture during melt kneading is not particularly limited. For example, from the viewpoint of giving a sufficient amount of shear heat energy and easily obtaining a molded article having excellent surface smoothness, the discharge rate may be 3 kg/hr or more and 30 kg/hr or less, 5 kg/hr or more and 20 kg/hr or less, or 7 kg/hr or more and 15 kg/hr or less. The discharge rate in the case of using an extruder with a larger screw diameter may be determined according to a general theoretical formula, and for example, the discharge rate has a good correspondence with the 2 to 3 power laws of the screw diameter. For example, when the 2.5 power law is applied to an extruder with a screw diameter of 58 mm, it is expressed as (69 mm)^{2.5}/(27 mm)^{2.5}=10.44, meaning that the discharge rate for molding can be set at about 10.44 times or more the discharge rate in the case of using an extruder with a screw diameter of 27 mm.

The melt-kneaded mixture may be dewatered, for example, through one or more dewatering vacuum vents provided in the cylinders.

In the case of using a batch mixer such as a kneader or a Banbury mixer, the thermoplastic resin composition can be obtained similarly to the case of using an extruder by performing a first step of melt mixing in a closed system in which water does not boil or volatilize under pressure, and performing a second step of releasing the pressure and dewatering. Then, as needed, the third step may be performed. After the second step or the third step, the molten thermoplastic resin composition can be pelletized by a common method using, e.g., a twin-screw taper extruder, a twin-screw extruder, a single-screw extruder, or a feeder ruder.

When the total of the polyester resin (A) and the starch material (B) is taken as 100 wt %, the thermoplastic resin composition preferably contains 50 wt % or more and 99 wt % or less of the polyester resin (A) and 1 wt % or more and 50 wt % or less of the starch material (B), more preferably 55 wt % or more and 95 wt % or less of the polyester resin (A) and 5 wt % or more and 45 wt % or less of the starch material (B), further preferably 60 wt % or more and 90 wt % or less of the polyester resin (A) and 10 wt % or more and 40 wt % of the starch material (B), and particularly preferably 60 wt % or more and 80 wt % or less of the polyester resin (A) and 20 wt % or more and 40 wt % or less of the starch material (B), from the viewpoint of balancing the surface smoothness and the biodegradability. A thermoplastic resin composition containing 99 wt % or less of the polyester resin (A) and 1 wt % or more of the starch material (B) yields a molded article with high biodegradability, and a thermoplastic resin composition containing 50 wt % or more of the polyester resin (A) and 50 wt % or less of the starch material (B) yields a molded article with improved surface smoothness. As described above, the starch material (B) normally contains water. In one or more embodiments of the present invention, the amount of the starch material (B) in the thermoplastic resin composition refers to the amount of the solid content of the starch material (B) excluding the moisture content. In the case of using a starch material not containing water, the amount of the solid content of the starch material is equal to the amount of the starch material.

When the total of the aliphatic-aromatic polyester resin (A1), the aliphatic polyester resin (A2), the starch material (B), and the polyhydroxybutyrate resin (C) is taken as 100 wt %, the thermoplastic resin composition preferably contains 50 wt % or more and 99 wt % or less of the aliphatic-aromatic polyester resin (A1), 1 wt % or more and 50 wt % or less of the starch material (B), and 0 wt % or more and 49 wt % or less of the sum of the aliphatic polyester resin (A2) and the polyhydroxybutyrate resin (C), more preferably 50 wt % or more and 90 wt % or less of the aliphatic-aromatic polyester resin (A1), 5 wt % or more and 45 wt % or less of the starch material (B), and 5 wt % or more and 45 wt % or less of the sum of the aliphatic polyester resin (A2) and the polyhydroxybutyrate resin (C), further preferably 50 wt % or more and 80 wt % or less of the aliphatic-aromatic polyester resin (A1), 10 wt % or more and 40 wt % or less of the starch material (B), and 10 wt % or more and 40 wt % or less of the sum of the aliphatic polyester resin (A2) and the polyhydroxybutyrate resin (C), and still further preferably 50 wt % or more and 70 wt % or less of the aliphatic-aromatic polyester resin (A1), 15 wt % or more and 40 wt % or less of the starch material (B), and 15 wt % or more and 30 wt % or less of the sum of the aliphatic polyester resin (A2) and the polyhydroxybutyrate resin (C), from the viewpoint of highly balancing the melt-kneadability, biodegradability, mechanical properties, and moldability.

The thermoplastic resin composition may contain the following other additives as needed as long as the effect of the present invention is not impaired: other resins such as polyvinyl acetate, a polyethylene-vinylacetate copolymer, polyvinyl alcohol, polyethylene vinyl alcohol resin, and cellulose resin; rubbers such as natural rubber; plasticizers such as a plasticizer for resin and a plasticizer for starch; fillers such as an inorganic filler and an organic filler; a compatibilizer; a crystal nucleating agent; an antioxidant; an anti-blocking agent; a UV absorber; a light-resistant agent; an antioxidant; a heat stabilizer; a colorant; a flame retardant; a release agent; an antistatic agent; an antifogging agent; a surface wetting improver; an incineration aid; a pigment; a lubricant; a dispersion aid; a surfactant; a slip agent; an anti-hydrolysis agent; and an end capping agent. The thermoplastic resin composition may contain one or two or more of the other additives. For example, the thermoplastic resin composition may contain 20 wt % or less of the other resins, 5 wt % or less of the plasticizers, and 10 wt % or less of the fillers based on 100 wt % of the thermoplastic resin composition. For example, the other additives excluding the plasticizers and the fillers may be contained in an amount of 5 parts by weight or less when the total amount of the resin components (the polyester resin (A) and the starch material (B), or the polyester resin (A), the starch material (B), and the polyhydroxybutyrate resin (C)) is taken as 100 parts by weight.

Any plasticizer that can be mixed with the starch material and reduce the viscosity may be used as the plasticizer for starch. Among them, alcohols are preferable, and bi- or higher-valent alcohols are particularly preferable. The boiling point of the plasticizer for starch is preferably, but not particularly limited to, 120° C. or higher, more preferably 160° C. or higher, and particularly preferably 200° C. or higher. Specifically, the plasticizer for starch is preferably at least one selected from the group consisting of glycerin, glycerin dimer, glycerin trimer, glycerin tetramer, polyglycerin, sorbitol, pentaerythritol, propylene glycol, and ethylene glycol, because of their high affinity for the starch material, and less migration to the thermoplastic resin when mixed with the thermoplastic resin, and less bleeding when molded. However, in addition to their low molecular weight, such plasticizers are compatible with water and alcohols, and the elution amount in water or in 20% ethanol at high temperatures often exceeds a specified amount required for food contact applications. When the total of the resin and the starch material is taken as 100 parts by weight, the addition amount of the plasticizer is preferably 3 parts by weight, more preferably 2 parts by weight, further preferably 1 part by weight, and particularly preferably 0.

Any known crystal nucleating substance may be used as the crystal nucleating agent. Examples of the crystal nucleating agent include inorganic substances such as pentaerythritol, boron nitride, titanium oxide, talc, phyllosilicate, calcium carbonate, sodium chloride, and metal phosphate; sugar alcohol compounds of natural origin such as erythritol, galactitol, mannitol, and arabitol; polyvinyl alcohol, chitin, chitosan, polyethylene oxide, aliphatic carboxylic acid amide, aliphatic carboxylate, aliphatic alcohol, aliphatic carboxylic acid ester, dicarboxylic acid derivatives such as dimethyl adipate, dibutyl adipate, diisodecyl adipate, and dibutyl sebacate; cyclic compounds having a functional group C═O and a functional group selected from NH, S, and O in the molecule, such as indigo, quinacridone, and quinacridone magenta; sorbitol derivatives such as bisbenzylidene sorbitol and bis(p-methylbenzylidene)sorbitol; compounds containing nitrogen-containing heteroaromatic nuclei, such as pyridine, triazine, and imidazole; phosphate ester compounds, bisamides of higher fatty acid, and metal salts of higher fatty acid; and branched polylactic acid. Pentaerythritol is preferable from the viewpoint of highly accelerating the crystallization rate. These crystal nucleating agents may be used alone or in combination of two or more.

The lubricant may be at least one selected from the group consisting of metal salts of aliphatic carboxylic acid and fatty acid amides. Of these, fatty acid amides are preferable. Specific examples of the fatty acid amides include oleamide, erucamide, behenamide, stearamide, palmitamide, N-stearyl behenamide, N-stearyl erucamide, ethylene bisstearamide, ethylene bisoleamide, ethylene biserucamide, ethylene bislauramide, ethylene biscapramide, p-phenylene bisstearamide, and a polycondensate of ethylenediamine and stearic acid and sebacic acid. Among these, erucamide is particularly preferable. With erucamide, the friction between the thermoplastic resin composition or its molded article and the apparatus or the like can be reduced further, and the film opening property can be improved further.

As the inorganic filler, inorganic particles such as silica, talc, calcium carbonate, barium sulfate, and magnesium silicate can be used. The silica is preferably wet silica from the viewpoint of dispersibility.

The pigment may be a commonly used pigment. In the film and bag applications, the use of pigment is suited not only for coloring but also for applications requiring concealing properties to make the content invisible.

The other additives may be added to the thermoplastic resin composition in the first step or the thermoplastic resin composition in the third step.

(Molded Article and its Production Method)

The thermoplastic resin composition has excellent biodegradability and mechanical properties, and it can be suitably used in various fields such as agriculture, fishery, forestry, gardening, medical science, sanitary goods, food industry, garments, non-garments, packing, automobile, and building materials. The thermoplastic resin composition can be suitably formed into various molded articles, including fiber products such as vegetation nets, garden nets, insect screens, young tree nets, guide strings, and windbreak nets, grocery bags, shopping bags, fruit and vegetable bags, rubber bags, compost bags, agricultural mulch films, forestry fumigation sheets, binding tapes including flat yarns, vegetation mats, weed barrier bags, weed barrier nets, weed barrier sheets, curing sheets, slope protection sheets, fly ash holding sheets, drain sheets, water retaining sheets, sludge and slime dehydrating bags, tunnel films, bird repelling sheets, seedling raising pots, seeder tapes, germination sheets, house lining sheets, root barrier sheets, print laminates, fertilizer bags, feed bags, sample bags, sandbags, vermin nets, medical films, wrap films, paper laminates, shrink films, shrink labels, window envelopes, hand tearable tapes, easy peel packages, egg packages, MD packages, compost bags, recording medium packages, shopping bags, wrapping films, release films, porous films, container bags, credit cards, cash cards, ID cards, drain bags, root wrapping films for plants, diaper backsheets, packaging sheets, film products, blister packages, cups, and lids. Among these, film-shaped and bag-shaped molded articles are preferable.

A common molding method can be used as the method for producing the molded article using the thermoplastic resin composition, and examples thereof include blow molding, inject molding, and extrusion molding.

Examples of the extrusion molding include inflation molding by which film-shaped or bag-shaped molded articles can be obtained, and T-die molding by which films (sheets) can be obtained.

The thermoplastic resin composition may also be formed into a monolayer or a multilayer by a common production method. For example, by using the thermoplastic resin composition of the present invention for the outer layer and using polyvinyl alcohol, polyethylene vinyl alcohol or the like having biodegradability and barrier properties for the inner layer, biodegradability and barrier properties are enhanced. Further, by using biodegradable resin such as polybutylene succinate, polylactic acid or the like solidifying quickly for the outer layer and using the thermoplastic resin composition of the present invention for the inner layer, biodegradability and productivity are further balanced.

If the molded article is a film, the film thickness may be, but not particularly limited to, 5 μm or more and 500 μm or less, 10 μm or more and 300 μm or less, 15 μm or more and 150 μm or less, or 10 μm or more and 120 μm or less. The film may be in a tubular shape.

(Film)

The present inventors have found that in the film containing the thermoplastic resin composition containing the biodegradable polyester resin (A) and the starch material (B), by causing the number-average particle diameter of the starch material (B) to be 3 μm or less, the starch material (B) is finely dispersed in the biodegradable polyester resin (A), thus improving the mechanical strength and the smoothness. Particularly, in the film containing the thermoplastic resin composition obtained in one or more embodiments of the present invention described above, the number-average particle diameter of the starch material (B) is more likely to be 3 μm or less. Further, the film containing the thermoplastic resin composition obtained in one or more embodiments of the present invention described above has less odor derived from the starch material (B).

In one or more embodiments of the present invention, the number-average particle diameter of the starch material (B) in the film was determined as follows. An ultrathin piece (thickness, 80 to 100 nm) approximately at the middle in the thickness direction of the film was cut out. The piece was observed using a transmission electron microscope, with the observation direction coinciding with the thickness direction of the film (the direction perpendicular to the film surface). 100 particles of the starch material (B) were extracted at random, and the individual particle diameters of the starch material were measured to calculate the number-average particle diameter. In the case of spherical particles, the diameter of a circle corresponding to the two-dimensional shape of the particle resulting from its cross-section was defined as the particle diameter. In the case of non-spherical particles, the particle diameter (d) was calculated from Formula (1) below, where d1 and d2 respectively represent the inner diameter and the outer diameter of an ellipse in which the particle can be inscribed or adjoined.

d=√(d1×d2) [Formula 1]

The number-average particle diameter of the starch material (B) in the film is preferably 2.5 μm or less, more preferably 2.0 μm or less, further preferably 1.5 μm or less, still further preferably 1.0 μm or less, and particularly preferably 0.50 μm or less. This improves the microdispersibility of the starch material (B) and develops the mechanical strength. The lower limit of the number-average particle diameter of the starch material (B) in the film is preferably as low as possible and not particularly limited. For example, from the viewpoint of the productivity, the lower limit may be 5 μm or more, or 10 μm or more.

The film has a tearing strength measured according to JIS P 8116 of preferably 150 N/mm or more, more preferably 160 N/mm or more, further preferably 170 N/mm or more, and particularly preferably 180 N/mm or more, from the viewpoint of high mechanical strength, particularly the tearing strength. The upper limit of the tearing strength in the film is preferably as high as possible and not particularly limited. For example, from the viewpoint of the productivity, the upper limit may be 500 N/mm or less, or 300 N/mm or less.

The film thickness may be, but not particularly limited to, 5 μm or more and 500 μm or less, 10 μm or more and 300 μm or less, 15 μm or more and 150 μm or less, or 10 μm or more and 120 μm or less. The film may be in a tubular shape.

The film may be a monolayer film or a laminate film having two or more layers. In the case of the laminate film, the thermoplastic resin composition containing the biodegradable polyester resin (A) and the starch material (B) may be contained in all the layers, and the number-average particle diameter of the starch material (B) may be 3 μm or less. Alternatively, the thermoplastic resin composition containing the biodegradable polyester resin (A) and the starch material (B) may be contained only in the outer layer, and the number-average particle diameter of the starch material (B) may be 3 μm or less. In this case, polyvinyl alcohol, polyethylene vinyl alcohol or the like having biodegradability and barrier properties may be used for the inner layer to improve the biodegradability and barrier properties.

Although not particularly limited, for example, the film can be produced appropriately using the thermoplastic resin composition of one or more embodiments of the present invention described above. The molding method is not particularly limited, and may be a known film formation method such as inflation molding or T-die molding.

### EXAMPLES

Hereinafter, the present invention will be described in more detail by way of examples and comparative examples. The present invention is not limited to these examples.

(Raw Material Used)

Table 1 below shows the detail of the used raw materials.

TABLE 1

| | Chemical name | Abbreviation | Trade name | Manufacturer | Remarks |
|---|---|---|---|---|---|
| Aliphatic-aromatic | Polybutylene adipate | PBAT | Ecoflex F Blend | BASF SE | |
| polyester resin (A1) | terephthalate | | C1200 | | |
| Aliphatic polyester | Polybutylene succinate | FZ91PB | BioPBS | MITSUBISHI CHEMICAL | |
| resin (A2) | | | FZ91PB | CORPORATION | |
| | Polybutylene succinate | FD92PB | BioPBS | MITSUBISHI CHEMICAL | |
| | adipate | | FD92PB | CORPORATION | |
| | Polycaprolactone | Capa 6500 | Capa 6500 | Ingevity | |
| | Polycaprolactone | Capa 6800 | Capa 6800 | Ingevity | |
| Starch substance (B) | Raw corn starch | Corn starch | Corn starch Y | Sanwa Starch Co., Ltd. | |
| | Chemically modified | Chemically | Food starch SG | Matsutani Chemical | |
| | corn starch | modified | | Industry Co., Ltd. | |
| | | corn starch | | | |
| Polyhydroxybutyrate | Poly(3-hydroxybutyrate- | X131N | X131N | KANEKA CORPORATION | Weight-average |
| resin (C) | co-3-hydroxyhexanoate) | | | | molecular weight = |
| | | | | | 520000, 3HH content = |
| | | | | | 5.4 mol % |
| | Poly(3-hydroxybutyrate- | M101 | M101 | KANEKA CORPORATION | Weight-average |
| | co-3-hydroxyhexanoate) | | | | molecular weight = |
| | | | | | 560000, 3HH content = |
| | | | | | 6.1 mol % |
| | Poly(3-hydroxybutyrate- | X151N | X151N | KANEKA CORPORATION | Weight-average |
| | co-3-hydroxyhexanoate) | | | | molecular weight = |
| | | | | | 570000, 3HH content = |
| | | | | | 11.2 mol % |
| Other additives | Wet silica | Silica | Nipsil LP | TOSOH SILICA | |
| | | | | CORPORATION | |

The following describes the measurement and evaluation methods used in the examples and comparative examples.

(Moisture Content of Starch Material)

A starch material sample was place on a heat-drying moisture meter (model “MX-50” manufactured by A&D Co., Ltd.) and measured at 160° C., and a volatile content ratio at which a change in volatile content became less than 0.02% was measured to calculate the moisture content (water content) of the starch material (B).

(Moisture Content of Melt-Kneaded Mixture)

1.0 to 1.5 g of a sample was collected from the strands at the die exit of the twin-screw extruder. After a lapse of 30 seconds, the sample was place on a heat-drying moisture meter (model “MX-50” manufactured by A&D Co., Ltd.) and measured at 160° C., and a volatile content ratio at which a change in volatile content became less than 0.02% was measured to calculate the moisture content (water content) of the melt-kneaded mixture.

(Film Thickness)

The thickness of the film was determined by measuring central thicknesses of the film in a resin flow direction (hereinafter, also referred to as MD) at intervals of 50 mm to a length of 400 mm with a thickness gauge, and arithmetically averaging the measured thicknesses.

(Surface Smoothness of Film)

The palm of the hand was moved along the surface of the film (length, 1 m) to perceive the unevenness to evaluate the surface smoothness of the film based on the following four grades.
A: The film has no unevenness and has no problem in practical use.
B: The film slightly has unevenness but has no problem in practical use.
C: The film has unevenness and has a problem in practical use.
D: The film has many unevenness and has a problem in practical use.

(Number-Average Particle Diameter)

As illustrate in the FIGURE, an ultrathin piece 4 (thickness, 80 to 100 nm) approximately at the middle (middle plane) 3 relative to a thickness direction 2 of a film 1 was cut out. The piece was observed using a transmission electron microscope, with an observation direction 5 coinciding with the thickness direction 2 of the film 1 (the direction perpendicular to the surface of the film 1). 100 particles of the starch material were extracted at random, and the individual particle diameters of the starch material were measured to calculate the number-average particle diameter. In the case of spherical particles, the diameter of a circle corresponding to the two-dimensional shape of the particle resulting from its cross-section was defined as the particle diameter. In the case of non-spherical particles, the particle diameter (d) was calculated from Formula (1) below, where d1 and d2 respectively represent the inner diameter and the outer diameter of an ellipse in which the particle can be inscribed or adjoined.

d=√(d1×d2) [Formula 1]

(Odor)

The film immediately after molding was brought into contact with the nose to perceive the burnt smell of the starch material to evaluate the odor based on the following four grades.
A: Burnt odor is not perceived.
B: The film has a weak burnt odor.
C: The film has a burnt odor.
D: The film has a strong burnt odor.

(Tearing Strength)

The film was stored for one week in an atmosphere of 50% relative humidity at 23° C. The tearing strength (Elmendorf tearing strength) of the film was determined by dividing, by the film thickness, MD values measured with a light load type tearing tester (No. 2037 special specification machine manufactured by KUMAGAI RIM KOGYO Co., Ltd.) having functions and structures that comply with a standard Elmendorf tearing tester specified in JIS P 8116.

### Example 1

(Compounding Using Twin-Screw Extruder)

A TEM-26SS (L/D=60) manufactured by TOSHIBA MACHINE CO., LTD., was set to have a screw configuration shown in Table 2. A main feed unit 1 was attached to a cylinder 1, a main feed unit 2 was attached to a cylinder 2, and a dewatering vent unit was attached to a cylinder 9. PBAT was fed at 4.66 kg/hr and a corn starch (containing 12.3 wt % of water) was fed at 2.67 kg/hr from the main feed part 1 of the cylinder 1, and water (ion-exchanged water, the same applies to the following) was supplied from the main feed part 2 of the cylinder 2 at 0.28 kg/hr, under the barrel temperature condition of Temp 1. These materials were compounded at a screw rotation speed of 250 rpm and passed through a water tank filled with water at 25° C. to solidify the strands, and the strands were cut with a pelletizer to produce pellets of the thermoplastic resin composition. The water content of the melt-kneaded mixture was 0.4 wt %. The melt-kneaded mixture was dewatered during compounding through the dewatering vacuum vent provided in the cylinder 9.

(Film Formation with T-Die Molding)

The pellets of the thermoplastic resin composition thus obtained were dried at 60° C. for 24 hours in a dehumidification dryer and formed into a film having a thickness of 99 μm under the molding temperature conditions of C1/C2/C3/die=160° C./170° C./180° C./180° C. using a Labo Plastomill 3S150 manufactured by Toyo Seiki Co., Ltd., equipped with a single-screw extruder D2020, a T-die T150C (lip width, 250 μm), and a film take-up device FT2W20 (roll temperature, 30° C.; take-up speed, 2 m).

### Example 2

Pellets and a film (thickness, 100 μm) of a thermoplastic resin composition of Example 2 were produced in the same manner as in Example 1 except that the water supply amount was changed to 0.40 kg/hr. The water content of the melt-kneaded mixture was 0.5 wt %.

### Example 3

Pellets and a film (thickness, 100 μm) of a thermoplastic resin composition of Example 3 were produced in the same manner as in Example 1 except that the water supply amount was changed to 0.53 kg/hr. The water content of the melt-kneaded mixture was 0.6 wt %.

### Example 4

Pellets and a film (thickness, 100 μm) of a thermoplastic resin composition of Example 4 were produced in the same manner as in Example 1 except that the water supply amount was changed to 0.63 kg/hr. The water content of the melt-kneaded mixture was 0.7 wt %.

### Example 5

Pellets and a film (thickness, 101 μm) of a thermoplastic resin composition of Example 5 were produced in the same manner as in Example 1 except that the water supply amount was changed to 0.81 kg/hr. The water content of the melt-kneaded mixture was 0.8 wt %.

### Comparative Example 1

Pellets and a film (thickness, 101 μm) of a thermoplastic resin composition of Comparative Example 1 were produced in the same manner as in Example 1 except that the water supply amount was changed to 0 kg/hr, that is, no water was supplied. The water content of the melt-kneaded mixture was 0.2 wt %.

### Comparative Example 2

Pellets and a film (thickness, 100 μm) of a thermoplastic resin composition of Comparative Example 2 were produced in the same manner as in Example 1 except that the water supply amount was changed to 0.18 kg/hr. The water content of the melt-kneaded mixture was 0.2 wt %.

### Comparative Example 3

Pellets and a film (thickness, 100 μm) of a thermoplastic resin composition of Comparative Example 3 were produced in the same manner as in Example 1 except that the water supply amount was changed to 0.22 kg/hr. The water content of the melt-kneaded mixture was 0.3 wt %.

### Comparative Example 4

Pellets and a film (thickness, 99 μm) of a thermoplastic resin composition of Comparative Example 4 were produced in the same manner as in Example 1 except that the water supply amount was changed to 1.02 kg/hr. The water content of the melt-kneaded mixture was 0.9 wt %.

### Example 6

(Preparation of Starch Pre-Blend)

A starch pre-blend was prepared in advance using a 75 L super mixer manufactured by KAWATAMFG. CO., LTD. Specifically, 8.01 kg of a corn starch (containing 12.3 wt % of water) was charged into a super mixer, and 1.2 kg of water was gradually added in 3 minutes under stirring at a rotation speed of 200 rpm. Stirring was once stopped to add 0.054 kg of silica, and then the mixture was mixed for another 1 minute at a rotation speed of 200 rpm to prepare a starch pre-blend having a water content of 23.7 wt % (the starch pre-blend was prepared in an amount required for 3 hours of compounding).

(Compounding Using Twin-Screw Extruder)

A TEM-26SS (L/D=60) manufactured by TOSHIBA MACHINE CO., LTD., was set to have a screw configuration shown in Table 2. The main feed unit 1 was attached to the cylinder 1, and the main feed unit 2 was attached to the cylinder 2. PBAT was fed from the main feed part 1 of the cylinder 1 at 4.66 kg/hr, and the starch pre-blend was fed from the main feed part 2 of the cylinder 2 at 3.088 kg/hr, under the barrel temperature condition of Temp 1. These materials were compounded at a screw rotation speed of 250 rpm and passed through a water tank filled with water at 25° C. to solidify the strands, and the strands were cut with a pelletizer to produce pellets of the thermoplastic resin composition. The water content of the melt-kneaded mixture was 0.5 wt %. The melt-kneaded mixture was dewatered during the compounding process through the dewatering vacuum vent provided in the cylinder 9.

(Film Formation with T-Die Molding)

A film of Example 6 having a thickness of 99 μm was obtained in the same manner as in Example 1.

### Example 7

A starch pre-blend, and pellets and a film (thickness, 101 μm) of a thermoplastic resin composition of Example 7 were produced in the same manner as in Example 6 except that the screw rotation speed during compounding using a twin-screw extruder was changed to 190 rpm. The water content of the melt-kneaded mixture was 0.5 wt %.

### Example 8

A starch pre-blend, and pellets and a film (thickness, 101 μm) of a thermoplastic resin composition of Example 8 were produced in the same manner as in Example 6 except that the screw rotation speed during compounding using a twin-screw extruder was changed to 135 rpm. The water content of the melt-kneaded mixture was 0.5 wt %.

### Example 9

A starch pre-blend, and pellets and a film (thickness, 101 μm) of a thermoplastic resin composition of Example 9 were produced in the same manner as in Example 8 except that the valve of the dewatering vacuum vent was adjusted in compounding using a twin-screw extruder so that the water content of the melt-kneaded mixture after the second step would be 1.5 wt %. In the compounding process using a twin-screw extruder, the strands at the die exit were slightly foamed, but pellets were obtained with no problem.

### Example 10

A starch pre-blend, and pellets and a film (thickness, 101 μm) of a thermoplastic resin composition of Example 10 were produced in the same manner as in Example 8 except that the valve of the dewatering vacuum vent was adjusted in compounding using a twin-screw extruder so that the water content of the melt-kneaded mixture after the second step would be 2.6 wt %. In the compounding process using a twin-screw extruder, the strands at the die exit were foamed, but pellets were obtained.

### Comparative Example 5

A starch pre-blend and pellets of a thermoplastic resin composition of Comparative Example 5 were attempted to be produced in the same manner as in Example 8 except that the valve of the dewatering vacuum vent was adjusted in compounding using a twin-screw extruder so that the water content of the melt-kneaded mixture after the second step would be 6.7 wt %. The strands at the die exit were foamed vigorously and could not be drawn, and pellets could not be obtained.

### Example 11

A starch pre-blend, and pellets and a film (thickness, 100 μm) of a thermoplastic resin composition of Example 11 were produced in the same manner as in Example 6 except that PBAT was changed to FZ91PB, and the barrel temperature condition was changed to Temp 2.

### Example 12

A starch pre-blend, and pellets and a film (thickness, 99 μm) of a thermoplastic resin composition of Example 12 were produced in the same manner as in Example 6 except that PBAT was changed to FZ92PB, and the barrel temperature condition was changed to Temp 2.

### Example 13

A starch pre-blend, and pellets and a film (thickness, 100 μm) of a thermoplastic resin composition of Example 13 were produced in the same manner as in Example 6 except that PBAT was changed to Capa 6500, and the barrel temperature condition was changed to Temp 2.

### Example 14

A starch pre-blend, and pellets and a film (thickness, 100 μm) of a thermoplastic resin composition of Example 14 were produced in the same manner as in Example 6 except that PBAT was changed to Capa 6800, and the barrel temperature condition was changed to Temp 2.

### Example 15

(Preparation of Starch Pre-Blend)

A starch pre-blend of Example 15 was prepared in the same manner as in Example 6 except that the amount of the corn starch charged was changed to 6.39 kg, the amount of water charged was changed to 0.96 kg, and the amount of the silica charged was changed to 0.042 kg for the preparation of the starch pre-blend.

(Compounding Using Twin-Screw Extruder)

Pellets of a thermoplastic resin composition of Example 15 were obtained in the same manner as in Example 6 except for the following. A TEM-26SS (L/D=60) manufactured by TOSHIBA MACHINE CO., LTD., was set to have a screw configuration shown in Table 2, the main feed unit 1 was attached to the cylinder 1, the main feed unit 2 was attached to the cylinder 2, a side feed unit was attached to a cylinder 11, and vent units were attached to the cylinder 9 and a cylinder 14. PBAT was fed from the main feed unit 1 of the cylinder 1 at 3.73 kg/hr, the starch pre-blend was fed from the main feed part 2 of the cylinder 2 at 2.464 kg/hr, and X131N was fed from the side feed part of the cylinder 11 at 1.4 kg/hr, under the barrel temperature condition of Temp 1. The melt-kneaded mixture was dewatered during the compounding process through the dewatering vacuum vents provided in the cylinder 9 and the cylinder 14. The water content of the final resulting melt-kneaded mixture was 0.5 wt %. The water content of the melt-kneaded mixture after the second step, i.e., the water content of the melt-kneaded mixture collected before feeding of X131N from the side feed of the cylinder 11, was also 0.5 wt %.

(Film Formation with T-Die Molding)

A film of Example 15 having a thickness of 100 μm was obtained in the same manner as in Example 1 except that the molding temperature conditions were changed to C1/C2/C3/die=135° C./145° C./155° C./165° C.

### Example 16

A starch pre-blend, and pellets and a film (thickness, 99 μm) of a thermoplastic resin composition of Example 16 were produced in the same manner as in Example 15 except that X131N was changed to M101. The water content of the final resulting melt-kneaded mixture and the water content of the melt-kneaded mixture after the second step were both 0.5 wt %.

### Example 17

A starch pre-blend, and pellets and a film (thickness, 100 μm) of a thermoplastic resin composition of Example 17 were produced in the same manner as in Example 15 except that X131N was changed to X151N. The water content of the final resulting melt-kneaded mixture and the water content of the melt-kneaded mixture after the second step were both 0.5 wt %.

### Example 18

A starch pre-blend, and pellets and a film (thickness, 101 μm) of a thermoplastic resin composition of Example 18 were produced in the same manner as in Example 15 except that X131N was changed to FD92PB. The water content of the final resulting melt-kneaded mixture and the water content of the melt-kneaded mixture after the second step were both 0.5 wt %.

### Example 19

A starch pre-blend, and pellets and a film (thickness, 101 μm) of a thermoplastic resin composition of Example 19 were produced in the same manner as in Example 15 except that X131N was changed to Capa 6800. The water content of the final resulting melt-kneaded mixture and the water content of the melt-kneaded mixture after the second step were both 0.5 wt %.

### Comparative Example 6

A starch pre-blend and pellets of a thermoplastic resin composition of Comparative Example 6 were attempted to be produced in the same manner as in Example 15 except that the valve of the dewatering vacuum vent was adjusted in compounding using a twin-screw extruder so that the water content of the melt-kneaded mixture after the second step would be 5.4 wt %. The strands at the die exit were foamed vigorously and could not be drawn, and pellets could not be obtained. In Comparative Example 6, more vigorous foaming was observed than in Comparative Example 5. Further, it was presumed that the melt viscosity was low, and the hydrolysis proceeded as compared with the case where the water content was low.

### Example 20

A starch pre-blend, and pellets and a film (thickness, 100 μm) of a thermoplastic resin composition of Example 20 were produced in the same manner as in Example 6 except that 8.01 kg of the corn starch and 1.2 kg of water were changed to 7.83 kg of a chemically modified corn starch and 1.38 kg of water, respectively.

TABLE 2

| | Screw | Barrel temperature conditions (° C.) | |
|---|---|---|---|
| Extruder | configuration | Temp 1 | Temp 2 |
| Cylinder 1 | Full flight | Water cooling | Water cooling |
| | | (20 ± 5° C.) | (20 ± 5° C.) |
| Cylinder 2 | Full flight | 80 | 80 |
| Cylinder 3 | Full flight | 80 | 80 |
| Cylinder 4 | Full flight | 80 | 80 |
| Cylinder 5 | Full flight | 80 | 80 |
| Cylinder 6 | Kneading | 110 | 110 |
| Cylinder 7 | Kneading | 110 | 110 |
| Cylinder 8 | Kneading | 130 | 110 |
| Cylinder 9 | Full flight | 130 | 110 |
| Cylinder 10 | Full flight | 160 | 160 |
| Cylinder 11 | Full flight | 160 | 160 |
| Cylinder 12 | Full flight | 160 | 160 |
| Cylinder 13 | Kneading | 160 | 160 |
| Cylinder 14 | Full flight | 160 | 160 |
| Cylinder 15 | Full flight | 160 | 160 |
| Die | Full flight | 180 | 180 |

Tables 3 to 7 below show the evaluation results of the surface smoothness and the odor of the films of Examples 1 to 20 and Comparative Examples 1 to 4. Tables 3 to 7 also show the production conditions and the composition of the thermoplastic resin compositions.

TABLE 3

| | | | Example 1 | | Example 2 | | Example 3 | |
|---|---|---|---|---|---|---|---|---|
| | | | Blended | | Blended | | Blended | |
| | | | amount | Supply | amount | Supply | amount | Supply |
| | | | (parts by | amount | (parts by | amount | (parts by | amount |
| | | | weight) | (kg/hr) | weight) | (kg/hr) | weight) | (kg/hr) |
| Thermoplastic | Aliphatic-aromatic | PBAT | 66.60 | 4.66 | 66.60 | 4.66 | 66.60 | 4.66 |
| resin | polyester resin (A1) | | | | | | | |
| composition | Solid content of | Corn starch | 33.40 | 2.34 | 33.40 | 2.34 | 33.40 | 2.34 |
| | starch material (B) | | | | | | | |
| | Water | Water derived from | 4.68 | 0.33 | 4.68 | 0.33 | 4.68 | 0.33 |
| | | starch material (B) | | | | | | |
| | | Added water | 4.00 | 0.28 | 5.70 | 0.40 | 7.50 | 0.53 |

| | | | | | | |
|---|---|---|---|---|---|---|
| Total | 108.68 | 7.61 | 110.38 | 7.73 | 112.18 | 7.85 |
| Starch material (B) (solid content + | 38.08 | 2.67 | 38.08 | 2.67 | 38.08 | 2.67 |
| water) | | | | | | |

| | | | | |
|---|---|---|---|---|
| | Water content per 100 parts by weight | 26.0 | 31.1 | 36.5 |
| | of solid content of starch material (B) | | | |
| | (parts by weight) | | | |
| | Water content of melt-kneaded mixture | 0.4 | 0.5 | 0.6 |
| | (wt %) | | | |
| Production | Discharge rate (kg/hr) | 7 | 7 | 7 |
| conditions | Screw rotation speed (rpm) | 250 | 250 | 250 |
| Film | Film smoothness | B | A | A |
| | Number-average particle diameter (μm) | 1.4 | 0.29 | 0.35 |
| | Odor | B | B | B |
| | Elmendorf tearing strength (N/mm) | 189 | 197 | 196 |

| | | | Example 4 | | Example 5 | |
|---|---|---|---|---|---|---|
| | | | Blended | | Blended | |
| | | | amount | Supply | amount | Supply |
| | | | (parts by | amount | (parts by | amount |
| | | | weight) | (kg/hr) | weight) | (kg/hr) |
| Thermoplastic | Aliphatic-aromatic | PBAT | 66.60 | 4.66 | 66.60 | 4.66 |
| resin | polyester resin (A1) | | | | | |
| composition | Solid content of | Corn starch | 33.40 | 2.34 | 33.40 | 2.34 |
| | starch material (B) | | | | | |
| | Water | Water derived from | 4.68 | 0.33 | 4.68 | 0.33 |
| | | starch material (B) | | | | |
| | | Added water | 9.00 | 0.63 | 11.50 | 0.81 |

| | | | | |
|---|---|---|---|---|
| Total | 113.68 | 7.96 | 116.18 | 8.13 |
| Starch material (B) (solid content + | 38.08 | 2.67 | 38.08 | 2.67 |
| water) | | | | |

| | | | |
|---|---|---|---|
| | Water content per 100 parts by weight | 41.0 | 48.5 |
| | of solid content of starch material (B) | | |
| | (parts by weight) | | |
| | Water content of melt-kneaded mixture | 0.7 | 0.8 |
| | (wt %) | | |
| Production | Discharge rate (kg/hr) | 7 | 7 |
| conditions | Screw rotation speed (rpm) | 250 | 250 |
| Film | Film smoothness | B | B |
| | Number-average particle diameter (μm) | 1.1 | 1.9 |
| | Odor | B | B |
| | Elmendorf tearing strength (N/mm) | 191 | 190 |

TABLE 4

| | | | Example 6 | | Example 7 | | Example 8 | |
|---|---|---|---|---|---|---|---|---|
| | | | Blended | | Blended | | Blended | |
| | | | amount | Supply | amount | Supply | amount | Supply |
| | | | (parts by | amount | (parts by | amount | (parts by | amount |
| | | | weight) | (kg/hr) | weight) | (kg/hr) | weight) | (kg/hr) |
| Thermoplastic | Aliphatic-aromatic | PBAT | 66.60 | 4.66 | 66.60 | 4.66 | 66.60 | 4.66 |
| resin | polyester resin (A1) | | | | | | | |
| composition | Solid content of | Corn starch | 33.40 | 2.34 | 33.40 | 2.34 | 33.40 | 2.34 |
| | starch material (B) | | | | | | | |
| | Water | Water derived from | 4.68 | 0.33 | 4.68 | 0.33 | 4.68 | 0.33 |
| | | starch material (B) | | | | | | |
| | | Added water | 5.70 | 0.40 | 5.70 | 0.40 | 5.70 | 0.40 |
| | Other additives | Silica | 0.25 | 0.018 | 0.25 | 0.018 | 0.25 | 0.018 |

| | | | | | | |
|---|---|---|---|---|---|---|
| Total | 110.63 | 7.74 | 110.63 | 7.74 | 110.63 | 7.74 |
| Starch material (B) (solid content + | 38.08 | 2.67 | 38.08 | 2.67 | 38.08 | 2.67 |
| water) | | | | | | |
| Starch pre-blend total | 44.03 | 3.088 | 44.03 | 3.088 | 44.03 | 3.088 |

| | | | | |
|---|---|---|---|---|
| | Water content per 100 parts by weight | 31.1 | 31.1 | 31.1 |
| | of solid content of starch material (B) | | | |
| | (parts by weight) | | | |
| | Water content of melt-kneaded mixture | 0.5 | 0.5 | 0.5 |
| | (wt %) | | | |
| Production | Discharge rate (kg/hr) | 7 | 7 | 7 |
| conditions | Screw rotation speed (rpm) | 250 | 190 | 135 |
| Film | Film smoothness | A | A | A |
| | Number-average particle diameter (μm) | 0.28 | 0.32 | 0.35 |
| | Odor | B | B | A |
| | Elmendorf tearing strength (N/mm) | 194 | 191 | 192 |

| | | | Example 9 | | Example 10 | |
|---|---|---|---|---|---|---|
| | | | Blended | | Blended | |
| | | | amount | Supply | amount | Supply |
| | | | (parts by | amount | (parts by | amount |
| | | | weight) | (kg/hr) | weight) | (kg/lir) |
| Thermoplastic | Aliphatic-aromatic | PBAT | 66.60 | 4.66 | 66.60 | 4.66 |
| resin | polyester resin (A1) | | | | | |
| composition | Solid content of | Corn starch | 33.40 | 2.34 | 33.40 | 2.34 |
| | starch material (B) | | | | | |
| | Water | Water derived from | 4.68 | 0.33 | 4.68 | 0.33 |
| | | starch material (B) | | | | |
| | | Added water | 5.70 | 0.40 | 5.70 | 0.40 |
| | Other additives | Silica | 0.25 | 0.018 | 0.25 | 0.018 |

| | | | | |
|---|---|---|---|---|
| Total | 110.63 | 7.74 | 110.63 | 7.74 |
| Starch material (B) (solid content + | 38.08 | 2.67 | 38.08 | 2.67 |
| water) | | | | |
| Starch pre-blend total | 44.03 | 3.088 | 44.03 | 3.088 |

| | | | |
|---|---|---|---|
| | Water content per 100 parts by weight | 31.1 | 31.1 |
| | of solid content of starch material (B) | | |
| | (parts by weight) | | |
| | Water content of melt-kneaded mixture | 1.5 | 2.6 |
| | (wt %) | | |
| Production | Discharge rate (kg/hr) | 7 | 7 |
| conditions | Screw rotation speed (rpm) | 135 | 135 |
| Film | Film smoothness | A | A |
| | Number-average particle diameter (μm) | 0.38 | 0.37 |
| | Odor | A | A |
| | Elmendorf tearing strength (N/mm) | 189 | 192 |

TABLE 5

| | | | Example 11 | | Example 12 | | Example 13 | |
|---|---|---|---|---|---|---|---|---|
| | | | Blended | | Blended | | Blended | |
| | | | amount | Supply | amount | Supply | amount | Supply |
| | | | (parts by | amount | (parts by | amount | (parts by | amount |
| | | | weight) | (kg/hr) | weight) | (kg/hr) | weight) | (kg/hr) |
| Thermoplastic | Aliphatic-aromatic | PBAT | | | | | | |
| resin | polyester resin (A1) | | | | | | | |
| composition | Aliphatic polyester | FZ91PB | 66.60 | 4.66 | | | | |
| | resin (A2) | FD92PB | | | 66.60 | 4.66 | | |
| | | Capa 6500 | | | | | 66.60 | 4.66 |
| | | Capa 6800 | | | | | | |
| | Solid content of | Corn starch | 33.40 | 2.34 | 33.40 | 2.34 | 33.40 | 2.34 |
| | starch material (B) | | | | | | | |
| | Water | Water derived from | 4.68 | 0.33 | 4.68 | 0.33 | 4.68 | 0.33 |
| | | starch material (B) | | | | | | |
| | | Added water | 5.70 | 0.40 | 5.70 | 0.40 | 5.70 | 0.40 |
| | Polyhydroxybutyrate | X131N | | | | | | |
| | resin (C) | | | | | | | |
| | Other additives | Silica | 0.25 | 0.018 | 0.25 | 0.018 | 0.25 | 0.018 |

| | | | | | | |
|---|---|---|---|---|---|---|
| Total | 110.63 | 7.74 | 110.63 | 7.74 | 110.63 | 7.74 |
| Starch material (B) (solid content + | 38.08 | 2.67 | 38.08 | 2.67 | 38.08 | 2.67 |
| water) | | | | | | |
| Starch pre-blend total | 44.03 | 3.088 | 44.03 | 3.088 | 44.03 | 3.088 |

| | | | | |
|---|---|---|---|---|
| | Water content per 100 parts by weight | 31.1 | 31.1 | 31.1 |
| | of solid content of starch material (B) | | | |
| | (parts by weight) | | | |
| | Water content of melt-kneaded mixture | 0.5 | 0.5 | 0.5 |
| | (wt %) | | | |
| Production | Discharge rate (kg/hr) | 7 | 7 | 7 |
| conditions | Screw rotation speed (rpm) | 250 | 250 | 250 |
| Film | Film smoothness | B | B | B |
| | Number-average particle diameter (μm) | 0.77 | 0.71 | 0.68 |
| | Odor | B | B | B |
| | Elmendorf tearing strength (N/mm) | 121 | 124 | 92 |

| | | | Example 14 | | Example 15 | |
|---|---|---|---|---|---|---|
| | | | Blended | | Blended | |
| | | | amount | Supply | amount | Supply |
| | | | (parts by | amount | (parts by | amount |
| | | | weight) | (kg/hr) | weight) | (kg/hr) |
| Thermoplastic | Aliphatic-aromatic | PBAT | | | 53.28 | 3.73 |
| resin | polyester resin (A1) | | | | | |
| composition | Aliphatic polyester | FZ91PB | | | | |
| | resin (A2) | FD92PB | | | | |
| | | Capa 6500 | | | | |
| | | Capa 6800 | 66.60 | 4.66 | | |
| | Solid content of | Corn starch | 33.40 | 2.34 | 26.72 | 1.87 |
| | starch material (B) | | | | | |
| | Water | Water derived from | 4.68 | 0.33 | 3.75 | 0.26 |
| | | starch material (B) | | | | |
| | | Added water | 5.70 | 0.40 | 4.55 | 0.32 |
| | Polyhydroxybutyrate | X131N | | | 20.00 | 1.40 |
| | resin (C) | | | | | |
| | Other additives | Silica | 0.25 | 0.018 | 0.20 | 0.014 |

| | | | | |
|---|---|---|---|---|
| Total | 110.63 | 7.74 | 108.50 | 7.59 |
| Starch material (B) (solid content + | 38.08 | 2.67 | 30.47 | 2.13 |
| water) | | | | |
| Starch pre-blend total | 44.03 | 3.088 | 35.22 | 2.464 |

| | | | |
|---|---|---|---|
| | Water content per 100 parts by weight | 31.1 | 31.1 |
| | of solid content of starch material (B) | | |
| | (parts by weight) | | |
| | Water content of melt-kneaded mixture | 0.5 | 0.5 |
| | (wt %) | | |
| Production | Discharge rate (kg/hr) | 7 | 7 |
| conditions | Screw rotation speed (rpm) | 250 | 250 |
| Film | Film smoothness | B | A |
| | Number-average particle diameter (μm) | 0.54 | 0.31 |
| | Odor | B | A |
| | Elmendorf tearing strength (N/mm) | 97 | 186 |

TABLE 6

| | | | Example 16 | | Example 17 | | Example 18 | |
|---|---|---|---|---|---|---|---|---|
| | | | Blended | | Blended | | Blended | |
| | | | amount | Supply | amount | Supply | amount | Supply |
| | | | (parts by | amount | (parts by | amount | (parts by | amount |
| | | | weight) | (kg/hr) | weight) | (kg/hr) | weight) | (kg/hr) |
| Thermoplastic | Aliphatic-aromatic | PBAT | 53.28 | 3.73 | 53.28 | 3.73 | 53.28 | 3.73 |
| resin | polyester resin (A1) | | | | | | | |
| composition | Solid content of | Corn starch | 26.72 | 1.87 | 26.72 | 1.87 | 26.72 | 1.87 |
| | starch material (B) | Chemically modified | | | | | | |
| | | corn starch | | | | | | |
| | Water | Water derived from | 3.75 | 0.26 | 3.75 | 0.26 | 3.75 | 0.26 |
| | | starch material (B) | | | | | | |
| | | Added water | 4.55 | 0.32 | 4.55 | 0.32 | 4.55 | 0.32 |
| | Polyhydroxybutyrate | M101 | 20.00 | 1.40 | | | | |
| | resin (C) | X151N | | | 20.00 | 1.40 | | |
| | Aliphatic polyester | FD92PB | | | | | 20.00 | 1.40 |
| | resin (A2) | Capa 6800 | | | | | | |
| | Other additives | Silica | 0.20 | 0.014 | 0.20 | 0.014 | 0.20 | 0.014 |

| | | | | | | |
|---|---|---|---|---|---|---|
| Total | 108.50 | 7.59 | 108.50 | 7.59 | 108.50 | 7.59 |
| Starch material (B) (solid content + | 30.47 | 2.13 | 30.47 | 2.13 | 30.47 | 2.13 |
| water) | | | | | | |
| Starch pre-blend total | 35.22 | 2.464 | 35.22 | 2.464 | 35.22 | 2.464 |

| | | | | |
|---|---|---|---|---|
| | Water content per 100 parts by weight | 31.1 | 31.1 | 31.1 |
| | of solid content of starch material (B) | | | |
| | (parts by weight) | | | |
| | Water content of melt-kneaded mixture | 0.5 | 0.5 | 0.5 |
| | (wt %) | | | |
| Production | Discharge rate (kg/hr) | 7 | 7 | 7 |
| conditions | Screw rotation speed (rpm) | 250 | 250 | 250 |
| Film | Film smoothness | A | A | A |
| | Number-average particle diameter (μm) | 0.29 | 0.32 | 0.31 |
| | Odor | A | A | A |
| | Elmendorf tearing strength (N/mm) | 177 | 181 | 182 |

| | | | Example 19 | | Example 20 | |
|---|---|---|---|---|---|---|
| | | | Blended | | Blended | |
| | | | amount | Supply | amount | Supply |
| | | | (parts by | amount | (parts by | amount |
| | | | weight) | (kg/hr) | weight) | (kg/hr) |
| Thermoplastic | Aliphatic-aromatic | PBAT | 53.28 | 3.73 | 66.60 | 4.66 |
| resin | polyester resin (A1) | | | | | |
| composition | Solid content of | Corn starch | 26.72 | 1.87 | | |
| | starch material (B) | Chemically modified | | | 33.40 | 2.34 |
| | | corn starch | | | | |
| | Water | Water derived from | 3.75 | 0.26 | 3.84 | 0.27 |
| | | starch material (B) | | | | |
| | | Added water | 4.55 | 0.32 | 6.55 | 0.46 |
| | Polyhydroxybutyrate | M101 | | | | |
| | resin (C) | X151N | | | | |
| | Aliphatic polyester | FD92PB | | | | |
| | resin (A2) | Capa 6800 | 20.00 | 1.40 | | |
| | Other additives | Silica | 0.20 | 0.014 | 0.25 | 0.018 |

| | | | | |
|---|---|---|---|---|
| Total | 108.50 | 7.59 | 110.64 | 7.74 |
| Starch material (B) (solid content + | 30.47 | 2.13 | 37.24 | 2.61 |
| water) | | | | |
| Starch pre-blend total | 35.22 | 2.464 | 44.04 | 3.088 |

| | | | |
|---|---|---|---|
| | Water content per 100 parts by weight | 31.1 | 31.1 |
| | of solid content of starch material (B) | | |
| | (parts by weight) | | |
| | Water content of melt-kneaded mixture | 0.5 | 0.5 |
| | (wt %) | | |
| Production | Discharge rate (kg/hr) | 7 | 7 |
| conditions | Screw rotation speed (rpm) | 250 | 250 |
| Film | Film smoothness | A | A |
| | Number-average particle diameter (μm) | 0.34 | 0.33 |
| | Odor | A | B |
| | Elmendorf tearing strength (N/mm) | 186 | 191 |

TABLE 7

| | | | Comparative | | Comparative | | Comparative | |
|---|---|---|---|---|---|---|---|---|
| | | | Example 1 | | Example 2 | | Example 3 | |
| | | | Blended | | Blended | | Blended | |
| | | | amount | Supply | amount | Supply | amount | Supply |
| | | | (parts by | amount | (parts by | amount | (parts by | amount |
| | | | weight) | (kg/hr) | weight) | (kg/hr) | weight) | (kg/hr) |
| Thermoplastic | Aliphatic-aromatic | PBAT | 66.60 | 4.66 | 66.60 | 4.66 | 66.60 | 4.66 |
| resin | polyester resin (A1) | | | | | | | |
| composition | Solid content of | Corn starch | 33.40 | 2.34 | 33.40 | 2.34 | 33.40 | 2.34 |
| | starch material (B) | | | | | | | |
| | Water | Water derived from | 4.68 | 0.33 | 4.68 | 0.33 | 4.68 | 0.33 |
| | | starch material (B) | | | | | | |
| | | Added water | 0.00 | 0.00 | 2.50 | 0.18 | 3.20 | 0.22 |
| | Polyhydroxybutyrate | X131N | | | | | | |
| | resin (C) | | | | | | | |
| | Other additives | Silica | | | | | | |
| | Total | | 104.68 | 7.33 | 107.18 | 7.50 | 107.88 | 7.55 |
| | Starch material (B) (solid content + | | 38.08 | 2.67 | 38.08 | 2.67 | 38.08 | 2.67 |
| | water) | | | | | | | |
| | Starch pre-blend total | | | | | | | |
| | Water content per 100 parts by weight | | 14.0 | | 21.5 | | 23.6 | |
| | of solid content of starch material (B) | | | | | | | |
| | (parts by weight) | | | | | | | |
| | Water content of melt-kneaded mixture | | 0.2 | | 0.2 | | 0.3 | |
| | (wt %) | | | | | | | |
| Production | Discharge rate (kg/hr) | | 7 | | 7 | | 7 | |
| conditions | Screw rotation speed (rpm) | | 250 | | 250 | | 250 | |
| Film | Film smoothness | | D | | D | | D | |
| | Number-average particle diameter (μm) | | 10.9 | | 6.1 | | 3.7 | |
| | Odor | | B | | B | | B | |
| | Elmendorf tearing strength (N/mm) | | 105 | | 124 | | 143 | |
| | | | Comparative | | Comparative | | Comparative | |
| | | | Example 4 | | Example 5 | | Example 6 | |
| | | | Blended | | Blended | | Blended | |
| | | | amount | Supply | amount | Supply | amount | Supply |
| | | | (parts by | amount | (parts by | amount | (parts by | amount |
| | | | weight) | (kg/hr) | weight) | (kg/hr) | weight) | (kg/hr) |
| Thermoplastic | Aliphatic-aromatic | PBAT | 66.60 | 4.66 | 66.60 | 4.66 | 53.28 | 3.73 |
| resin | polyester resin (A1) | | | | | | | |
| composition | Solid content of | Corn starch | 33.40 | 2.34 | 33.40 | 2.34 | 26.72 | 1.87 |
| | starch material (B) | | | | | | | |
| | Water | Water derived from | 4.68 | 0.33 | 4.68 | 0.33 | 3.75 | 0.26 |
| | | starch material (B) | | | | | | |
| | | Added water | 14.50 | 1.02 | 5.70 | 0.40 | 4.55 | 0.32 |
| | Polyhydroxybutyrate | X131N | | | | | 20.00 | 1.40 |
| | resin (C) | | | | | | | |
| | Other additives | Silica | | | 0.25 | 0.018 | 0.20 | 0.014 |

| | | | | | | |
|---|---|---|---|---|---|---|
| Total | 119.18 | 8.34 | 110.63 | 7.74 | 108.50 | 7.59 |
| Starch material (B) (solid content + | 38.08 | 2.67 | 38.08 | 2.67 | 30.47 | 2.13 |
| water) | | | | | | |
| Starch pre-blend total | | | 44.03 | 3.088 | 35.22 | 2.464 |

| | | | | |
|---|---|---|---|---|
| | Water content per 100 parts by weight | 57.4 | 31.1 | 31.1 |
| | of solid content of starch material (B) | | | |
| | (parts by weight) | | | |
| | Water content of melt-kneaded mixture | 0.9 | 6.7 | 5.4 |
| | (wt %) | | | |
| Production | Discharge rate (kg/hr) | 7 | 7 | 7 |
| conditions | Screw rotation speed (rpm) | 250 | 135 | 250 |
| Film | Film smoothness | D | — | — |
| | Number-average particle diameter (μm) | 4.2 | | |
| | Odor | B | — | — |
| | Elmendorf tearing strength (N/mm) | 139 | | |

The data of Tables 3 to 6 indicate that among the mixtures containing the polyester resin (A), the starch material (B), and water, the examples using the mixture containing 25 parts by weight or more and 55 parts by weight or less of water per 100 parts by weight of the solid content of the starch material (B) resulted in high film smoothness with almost no odor. The smoothness of the films of Examples 2 and 3 was superior to that of the films of Examples 1, 4, and 5, indicating that mixing 30 parts by weight or more and 40 parts by weight or less of water per 100 parts by weight of the solid content of the starch material (B) further improved the smoothness of the resultant films. The odor of the film of Example 8 was less perceivable than that of the films of Examples 6 and 7, indicating that the screw rotation speed of 160 rpm or less dining melt kneading more effectively removed the odor. The smoothness of the film of Example 2 was superior to that of the films of Examples 11 to 14, indicating that the aliphatic-aromatic polyester resin (A1) further improved the film smoothness. The odor of the films of Examples 15 to 19 was less perceivable than that of the films of Examples 2 and 6, indicating that performing the third step of further adding at least one selected from the group consisting of the aliphatic polyester resin (A2) and the polyhydroxybutyrate resin (C) to the melt-kneaded mixture obtained in the second step and melt-kneading it more effectively removed the odor.

On the other hand, the data of Table 7 indicate that Comparative Examples 1 to 3 where the mixture containing less than 25 parts by weight of water per 100 parts by weight of the solid content of the starch material (B) was melt-kneaded and Comparative Example 4 where the mixture containing more than 55 parts by weight of water per 100 parts by weight of the solid content of the starch material (B) was melt-kneaded resulted in poor film smoothness. Moreover, in Comparative Examples 5 and 6 where the water content of the melt-kneaded mixture after the second step exceeded 5 wt %, the strands at the die exit were vigorously foamed and could not be drawn, and pellets of the thermoplastic resin composition could not be obtained.

Further, in the examples, the number-average particle diameter of the starch material (B) in the films was 3 μm or less, and thus the starch material (B) was highly and finely dispersed in the polyester resin (A), and the surface smoothness was high. The films of the examples also had high tearing strength.

On the other hand, in the films of the comparative examples, the number-average particle diameter of the starch material (B) exceeded 3 μm, and the microdispersibility was inferior. The films of the comparative examples had low tearing strength.

Although not particularly limited, the present invention includes one or more of the following aspects, for example.

[1] A method for producing a thermoplastic resin composition containing a biodegradable polyester resin (A) and a starch material (B), the method including:

a first step of melt-kneading a mixture containing the biodegradable polyester resin (A), the starch material (B), and water, the mixture containing the water in an amount of 25 parts by weight or more and 55 parts by weight or less per 100 parts by weight of the solid content of the starch material (B); and

a second step of dewatering the melt-kneaded mixture to reduce a water content of the melt-kneaded mixture to 5 wt % or less.

[2] The method according to [1], wherein the biodegradable polyester resin (A) contains at least one selected from the group consisting of:

an aliphatic-aromatic polyester resin (A1) containing at least one dicarboxylic acid unit selected from the group consisting of an aliphatic dicarboxylic acid unit and an aromatic dicarboxylic acid unit, and at least one diol unit selected from the group consisting of an aliphatic diol unit and an aromatic diol unit; and

an aliphatic polyester resin (A2) (other than a polyhydroxybutyrate resin) containing an aliphatic dicarboxylic acid unit and an aliphatic diol unit.

[3] The method according to [2], including a third step of further adding at least one selected from the group consisting of the aliphatic polyester resin (A2) and a polyhydroxybutyrate resin (C) to the melt-kneaded mixture obtained in the second step, followed by melt kneading.
[4] The method according to any of [1] to [3], wherein the biodegradable polyester resin (A) contains at least one selected from the group consisting of a polybutylene adipate terephthalate resin, a polybutylene succinate resin, and a polycaprolactone resin.
[5] The method according to [3] or [4], wherein the polyhydroxybutyrate resin (C) is poly-(3-hydroxybutyrate-co-3-hydroxyhexanoate).
[6] The method according to any of [1] to [5], wherein when a total weight of the biodegradable polyester resin (A) and the starch material (B) to be fed from a main feed part of an extruder for melt kneading is taken as 100 wt %, the biodegradable polyester resin (A) is 50 wt % or more and 99 wt % or less, and the starch material (B) is 1 wt % or more and 50 wt % or less.
[7] The method according to any of [3] to [6], wherein when M represents the total weight of the biodegradable polyester resin (A) and the starch material (B) to be fed from the main feed part of the extruder for melt kneading, S represents a total weight of the aliphatic polyester resin (A2) and the polyhydroxybutyrate resin (C) to be fed from a side feed part of the extruder for melt kneading, and a total of M and S is taken as 100 wt %, M is 30 wt % or more and 85 wt % or less, and S is 15 wt % or more and 70 wt % or less.
[8] A method for producing a molded article including a step of molding the thermoplastic resin composition produced by the method according to any of [1] to [7].
[9] The method according to [8], wherein the molded article is a film.
[10] The method according to [9], wherein the starch material (B) in the film has a number-average particle diameter of 3 μm or less.
[11] The method according to [9] or [10], wherein the film has a tearing strength of 150 N/mm or more.
[12] A film containing a thermoplastic resin composition containing a biodegradable polyester resin (A) and a starch material (B),

wherein the starch material (B) has a number-average particle diameter of 3 μm or less.

[13] The film according to [12], wherein the film has a tearing strength of 150 N/mm or more.

### DESCRIPTION OF REFERENCE NUMERALS

1 Film
2 Thickness direction
3 Approximately at the middle in the thickness direction
4 Ultrathin piece
5 Observation direction

1. A method for producing a thermoplastic resin composition, the method comprising:
melt-kneading a mixture comprising a biodegradable polyester resin (A), a starch material (B), and water, wherein the mixture comprises from 25 to 55 parts by weight of the water per 100 parts by weight of a solid content of the starch material (B); and
dewatering the melt-kneaded mixture to reduce a water content of the melt-kneaded mixture to 5% by weight or less.

2. The method according to claim 1, wherein the biodegradable polyester resin (A) comprises at least one selected from the group consisting of:
an aliphatic-aromatic polyester resin (A1) comprising at least one dicarboxylic acid unit selected from the group consisting of an aliphatic dicarboxylic acid unit and an aromatic dicarboxylic acid unit, and at least one diol unit selected from the group consisting of an aliphatic diol unit and an aromatic diol unit; and
an aliphatic polyester resin (A2) other than a polyhydroxybutyrate resin.

3. The method according to claim 2, further comprising, after the dewatering:
adding, to the dewatered melt-kneaded mixture, at least one selected from the group consisting of the aliphatic polyester resin (A2) and a polyhydroxybutyrate resin (C), followed by melt kneading.

4. The method according to claim 1, wherein the biodegradable polyester resin (A) comprises at least one selected from the group consisting of a polybutylene adipate terephthalate resin, a polybutylene succinate resin, and a polycaprolactone resin.

5. The method according to claim 3, wherein the polyhydroxybutyrate resin (C) is poly-(3-hydroxybutyrate-co-3-hydroxyhexanoate).

6. The method according to claim 1, wherein when a total weight of the biodegradable polyester resin (A) and the starch material (B) to be fed from a main feed part of an extruder for the melt-kneading is taken as 100% by weight, the biodegradable polyester resin (A) is from 50% to 99% by weight, and the starch material (B) is from 1% to 50% by weight.

7. The method according to claim 3, wherein when M represents a total weight of the biodegradable polyester resin (A) and the starch material (B) to be fed from a main feed part of an extruder for the melt-kneading, S represents a total weight of the aliphatic polyester resin (A2) and the polyhydroxybutyrate resin (C) to be fed from a side feed part of the extruder, and a total of M and S is taken as 100% by weight, M is from 30% to 85% by weight, and S is from 15% to 70% by weight.

8. A method for producing a molded article, the method comprising:
molding the thermoplastic resin composition produced by the method according to claim 1.

9. The method according to claim 8, wherein the molded article is a film.

10. The method according to claim 9, wherein the starch material (B) in the film has a number-average particle diameter of 3 μm or less.

11. The method according to claim 9, wherein the film has a tearing strength of 150 N/mm or more.

12. A film, comprising:
a thermoplastic resin composition comprising a biodegradable polyester resin (A) and a starch material (B),
wherein the starch material (B) has a number-average particle diameter of 3 μm or less.

13. The film according to claim 12, wherein the film has a tearing strength measured according to JIS P 8116 of 150 N/mm or more.

14. The film according to claim 12, wherein the biodegradable polyester resin (A) comprises at least one selected from the group consisting of:
an aliphatic-aromatic polyester resin (A1) comprising at least one dicarboxylic acid unit selected from the group consisting of an aliphatic dicarboxylic acid unit and an aromatic dicarboxylic acid unit, and at least one diol unit selected from the group consisting of an aliphatic diol unit and an aromatic diol unit; and
an aliphatic polyester resin (A2) other than a polyhydroxybutyrate resin.

15. The film according to claim 12, wherein the biodegradable polyester resin (A) comprises at least one selected from the group consisting of a polybutylene adipate terephthalate resin, a polybutylene succinate resin, and a polycaprolactone resin.

16. The film according to claim 15, wherein the thermoplastic resin composition further comprises a polyhydroxybutyrate resin (C).

17. The film according to claim 16, wherein the polyhydroxybutyrate resin (C) is poly-(3-hydroxybutyrate-co-3-hydroxyhexanoate).

18. The film according to claim 16,
wherein the biodegradable polyester resin (A) comprises an aliphatic-aromatic polyester resin (A1) and optionally an aliphatic polyester resin (A2) other than a polyhydroxybutyrate resin,
when a total of the aliphatic-aromatic polyester resin (A1), the aliphatic polyester resin (A2), the starch material (B), and the polyhydroxybutyrate resin (C) is taken as 100% by weight, the thermoplastic resin composition comprises from 50% to 70% by weight of the aliphatic-aromatic polyester resin (A1), from 15% to 40% by weight of the starch material (B), and from 15% to 30% by weight of a sum of the aliphatic polyester resin (A2) and the polyhydroxybutyrate resin (C), and
the aliphatic-aromatic polyester resin (A1) comprises at least one dicarboxylic acid unit selected from the group consisting of an aliphatic dicarboxylic acid unit and an aromatic dicarboxylic acid unit, and at least one diol unit selected from the group consisting of an aliphatic diol unit and an aromatic diol unit.

19. The film according to claim 18, wherein the aliphatic-aromatic polyester resin (A1) comprises a polybutylene adipate terephthalate resin, and the aliphatic polyester resin (A2) comprises at least one selected from the group consisting of a polybutylene succinate resin and a polycaprolactone resin.

20. The film according to claim 12, wherein the film does not contain a plasticizer for starch.
